(19) United States
(12) Patent Application Publication
(10) Pub. No.: US 2005/0250402 A1
(43) Pub. Date: Nov. 10, 2005

(54) Polyolefin-containing wipes

(76) Inventors: Christine Wild, Hilden (DE); Ulrich Issberner, Rommerskirchen (DE)

Correspondence Address: COGNIS CORPORATION;PATENT DEPARTMENT, 300 BROOKSIDE AVENUE, AMBLER, PA, 19002, US

(21) Appl. No.: 11/113,558

(22) Filed: Apr. 25, 2005

(30) Foreign Application Priority Data
Apr. 24, 2004 (DE) 10 2004 020 083.1

(51) Int. Cl. B32B 3/00; D04H 5/00; D04H 1/00; D04H 3/00; B32B 27/12; B32B 27/04; B32B 9/00; B32B 5/02; D04H 13/00; B32B 27/02

(52) U.S. Cl. 442/118; 442/170; 442/327

(57) ABSTRACT

The invention are wipes obtainable by permanent hydrophilicizing of polyolefin-containing materials with a hydrophilicizing additive and subsequent impregnation of the nonwovens produced from these materials with spin finishes, aqueous solutions and emulsions, to the use of permanently hydrophilicized polyolefin-containing materials for the production of wipes and to the corresponding production process.

### CROSS-REFERENCE TO RELATED APPLICATIONS

This application claims priority from German application DE 102004020083.1 filed Apr. 24, 2001, the entire contents of which are incorporated herein by reference.

### FIELD OF THE INVENTION

This invention relates generally to the field of textiles and, more particularly, to polyolefin-containing wipes which are permanently hydrophilicized by hydrophilicizing additives and subsequently subjected to impregnation with spin finishes and/or aqueous solutions and/or emulsions. The invention also relates to the use of permanently hydrophilicized polyolefin-containing materials and to the corresponding process for the production of wipes.

### BACKGROUND OF THE INVENTION

Wipes used for personal hygiene, such as facial wipes, cosmetic pads, baby wipes, toilet wipes and wipes for use in the home and in the industrial sector, are mostly used in aqueous medium and require good wettability with polar liquids. Accordingly, hydrophilic fibers, such as cellulose fibers, such as viscose or pulp, or combinations thereof with polyester or polypropylene, have hitherto mostly been used for the production of wipes. The nonwoven material is formed by a so-called air-laid or carding process followed by chemical, thermal or mechanical bonding. These so-called staple fiber nonwovens often have inadequate abrasion resistance. Acceptable abrasion resistance values have to be acquired at the expense of inferior sensory properties.

Accordingly, there is a need to produce nonwovens which are either produced solely from a spunbonded material or have a composite structure in which at least one layer consists of a spunbonded material.

Spunbondeds are generally produced from thermoplastics (polyesters, polyolefins). In view of the poor water absorption of the pure polymers, spunbondeds cannot be used for wipes required to absorb hydrophilic substances or aqueous emulsions without the addition of hydrophilic additives.

In principle, the fibers can be given the necessary hydrophilic properties by subsequent coating with suitable products (spin finishes) or can be made sufficiently hydrophilic by the incorporation of suitable additives (internal additives) during their production. The second of these two options is described in EP 723 607 B1 which discloses diesters of polyethylene glycol with fatty acids or derivatives thereof as suitable permanent additives. In addition, European patent application EP 1 138 810 A1 describes special reaction products of two parts of a C₁₀₋₁₂ fatty acid with polyethylene glycols which are suitable as internal additives for hydrophilicizing polyolefin fibers. Similarly, International patent application WO 02/092891 describes hydrophilicizing additives for the permanent internal hydrophilicization of polyolefins.

Additives such as these are generally processed with polyolefin granules to form a masterbatch which is then added as such to the polymer granules before processing to the fibers or other end products, followed by extrusion. The additives described in WO 02/092891 may even be added during the actual extrusion process in the extruder.

The impregnation of tissue papers and wipes with surfactants or care components in the household, personal hygiene and cosmetic fields has been commercially successful for years. Starting from the cleaning function for which the first marketable wipes were designed, care is now increasingly the focus of attention. For example, International patent application WO 95/35411 proposes wet wipes impregnated with a lotion which, besides mineral oil, contains fatty acid esters, fatty alcohol ethoxylates and fatty alcohols.

Dry wipes which have to be moistened before use have also been available for some time, cf. International patent applications WO 99/13861 and WO 01/08657. Depending on the materials used, dry wipes are relatively expensive to produce, particularly because many materials cannot be recycled.

Despite their commercial maturity, conventional wipes are still in need of improvement so far as their performance properties are concerned.

The problem addressed by the present invention was to provide multi-purpose wipes which, despite inexpensive production, would have favorable performance, cleaning and care properties.

### BRIEF DESCRIPTION OF THE INVENTION

The present invention relates to wipes obtainable by permanent hydrophilicizing of polyolefin-containing materials with a hydrophilicizing additive and subsequent impregnation of the nonwovens produced from these materials with spin finishes and/or aqueous solutions and/or emulsions.

It has surprisingly been found that the wipes according to the invention on the one hand show better release of the solutions and emulsions with which they are impregnated, as reflected in a more pleasant feeling of the skin after application. Through the combination of an impregnation with an emulsion (o/w or w/o), two-phase cleaning wipes can be produced which, initially, have a cooling/cleaning effect on the skin and ultimately leave a creaming effect behind on the skin. This effect is evident not only in the case of spunbondeds, but also in the case of carded fleeces containing polypropylene stable fibers.

On the other hand, there is no sign of settling or “bleeding” of the impregnating solutions, even in the event of prolonged storage of packed wipes. Packs of conventional wipes stored for only a few days are characterized by sinking of the outer phase of the emulsion or—in the case of solutions—the entire solution within the pack due to the effect of gravity and capillary forces. With packs of the wipes according to the invention, this uneven distribution of the impregnating medium is avoided, so that there is no danger of the uppermost wipes in a pack drying out. In addition, the nonwovens according to the invention show excellent abrasion resistance.

The wipes according to the invention are also distinguished by relatively inexpensive production, by a higher production rate and by their lower weight coupled with a very high level of softness. This softness is achieved by the addition of the hydrophilic additives to polypropylene. The abrasion-resistant nonwovens additionally improve the cleaning effect because greater pressure can be applied in use by comparison with pure stable fiber nonwovens. In addition, the pure polyolefin nonwovens can be re-used by recycling which is not the case where they are combined with cellulose fibers.

So far as the conversion of the wipes is concerned, it is important that the wipes fold easily and do not unfold from one another on their own during the conversion process. The light weight of the nonwovens and the softness achieved by hydrophilic additives have a favorable influence on this memory effect by comparison with pure PES/viscose blends.

The wipes may be used for personal hygiene in the form of facial wipes, cosmetic pads, baby wipes, toilet wipes and also cleaning wipes for the home and for the industrial sector. The wipes may be dry wipes or so-called wet wipes. Hydrophilic polyolefin nonwovens absorb hydrophilic solvents, such as water, alcohols, glycols, to almost the same extent as they do hydrophobic substances, such as mineral oils, ester oils and silicone oils. This property is particularly desirable for industrial wipes which are expected to show high absorption of both hydrophilic and hydrophobic substances.

Accordingly, the present invention also relates to permanently hydrophilicized polyolefin materials for the production of impregnated wipes.

The present invention also relates to a process for the production of wipes, in which polyolefin-containing materials are permanently hydrophilicized with a hydrophilicizing additive and the resulting nonwovens are subjected to impregnation with spin finishes and/or aqueous solutions and/or emulsions.

The polyolefin-containing materials are permanently internally hydrophilicized in known manner and the resulting wipes are subsequently impregnated. Impregnation is carried out by spraying, immersion, printing or roller application, repeated impregnation with the same or different formulations being possible.

The solutions/emulsions of spin finishes typically used have proved to be effective for the first impregnation. Typical media for the first impregnation are spin finishes consisting of surfactants and oils which, in aqueous solution/emulsion, have a surface tension of less than 45 dyn/cm at 20° C. and at in-use concentration, such as for example Stantex® S 6327 (Cognis Düsseldorf), Stantex® S 6051-1 (Cognis Düsseldorf). This first impregnation leads to uniform hydrophilia and absorption onto the nonwoven and has a favorable effect on the distribution of the second impregnation.

The media for the second impregnation are solutions/emulsions consisting of surfactants in the case of wipes intended mainly for household and industrial cleaning purposes or of surfactants and/or skin-care components in the case of wipes for personal hygiene. In the case of emulsions, aqueous systems containing care components, such as for example Belsoft Care® 6600 (Cognis Düsseldorf), or even so-called PIT (phase inversion temperature) emulsions, such as Emulgade® CM (Cognis Düsseldorf), have proved to be particularly effective.

Any production processes for nonwovens (air-laid, carding, wet-laid, melt-spun, including melt-blown, or spunbond) and bonding processes (chemical, thermal, mechanical, including water jet stabilization) may be used. Various spunbond and bonding processes may be combined to produce composite nonwovens. In their case, the initial impregnation may even be carried out on the individual nonwovens before bonding, followed by a second impregnation.

Hydrophilicizing Additives

Suitable hydrophilicizing additives are the already known reaction products of 1 part polyethylene glycol to 2 parts fatty acids, preferably C₁₀₋₁₂ fatty acids or derivatives thereof, for permanently hydrophilicizing polyolefin-containing materials.

Also suitable are additives corresponding to general formula (I):
A-B-C-B-A (I)
where A represents a group R—COO in which R is a saturated, branched or unbranched C₇₋₂₁ alkyl group, B represents a group (CₙH₂ₙO)ₖ in which n is an integer of 2 to 4 and k has a value of 1 to 15, and C is a linear or branched alkylene group containing at least 2 and at most 6 carbon atoms which may also be interrupted by oxygen atoms. The index k relates to the individual group B and does not indicate the total number of groups B in the molecule. The index k varies on account of the varying, technically related degrees of alkoxylation of the individual molecules and, accordingly, may also be an odd number.

The compounds corresponding to general formula (I) are obtained, for example, by reaction of diols, for example polyalkylene glycols, with alkoxides and with saturated fatty acids. On the one hand, diols containing 2 to 6 carbon atoms, which form structural unit C of the additives according to the invention, and ethylene, propylene and/or butylene oxide which form the groups B in the compounds according to the invention must be present. The free hydroxyl groups of the alkoxides are terminated by saturated C₈₋₂₂ fatty acids.

The diols are preferably selected from the group consisting of ethane-1,2-diol, propane-1,2-diol, propane-1,3-diol and butane-1,4-diol. In principle, mixtures of the diols may also be used although it has proved to be of advantage to use only one diol for the reaction. Depending on the diol with which the synthesis process was started, the compounds (I) obtained contain different groups C. This difunctional group is preferably a CH₂—CH₂, CH₂—CH(CH₃), CH₂—CH₂—CH₂ or (CH₂)₄ group.

However, it can also be of advantage for the group C to contain one or more oxygen atoms. This preferably applies to an additive started on the basis of diethylene glycol, dipropylene glycol or similar ether compounds. In this case, C in formula (I) is a difunctional group CH₂—CH₂—O—CH₂—CH₂—O or (CH₂)₃—O—(CH₂)₃—O.

The alkoxides are selected from the group consisting of ethylene oxide, propylene oxide and butylene oxide and mixtures thereof. If alkoxides of different types are reacted, the alkoxylation reaction may be carried out both blockwise and at random. The number of alkoxide units in the compounds of formula (I) varies from 2 to 30 so that k may assume a value of 1 to 15. Preferred compounds of formula (I) are those in which k has a value of 2 to 15, preferably 4 to 10 and more particularly 10 or 5. Other preferred compounds of formula (I) also contain ethylene oxide units as the group B, preferably only ethylene oxide units. However, compounds containing only propylene oxide groups may also be used. In addition, mixed alkoxylates, preferably ethylene oxide and propylene oxide groups, are preferred. In these cases, the number of ethylene oxide groups should at least be equal to the number of propylene oxide groups (PO) and an excess of ethylene oxide groups (EO) should preferably be present. EO: PO ratios of 5:1 to 2:1 are preferred.

Suitable saturated fatty acids which can form group A of the compounds according to the invention are preferably selected from the group consisting of octanoic acid, nonanoic acid, decanoic acid, undecanoic acid, dodecanoic aid, tridecanoic acid, tetradecanoic acid, pentadecanoic acid, hexadecanoic acid, heptadecanoic acid and octadecanoic acid; nonadecanoic acid, eicosanoic acid and heneicosanoic acid; and docosanoic acid. Compounds corresponding to formula (I), in which R is a saturated C₉₋₁₃ or C₉₋₁₁ alkyl group, are preferred. Compounds corresponding to formula (I) based on decanoic acid (C₁₀) and undecanoic acid (C₁₁) are most particularly preferred.

Unsaturated acids may also be used although compounds of formula (I) of which the substituents have unsaturated functionalities do show inadequate oxidation stability.

Preferred compounds of formula (I) suitable as additives in accordance with the invention are those in which R is a linear alkyl group containing 9 carbon atoms, k has a value of 5, n has a value of 2 and C is a group CH₂—CH(CH₃) or in which R is a linear alkyl group containing 11 carbon atoms, k has a value of 5, n has a value of 2 and C is a group CH₂—CH₂(CH₃). Other preferred hydrophilicizing additives are compounds (I) in which A is a group R—COO, where R is a saturated, branched or unbranched C₇₋₂₁ alkyl group, B is a group C₃H₆ and C is a group CH₂—CH₂—O—CH₂—CH₂—O. Another preferred additive of formula (I) contains a diethylene glycol residue as part C, 5 to 7 parts EO and 2 to 4 parts PO as the groups B and a lauric acid residue as the substituent R.

The additives according to the invention may be used on their own or in admixture with one another. In addition, other additives known from the prior art for the extrusion or production of polymers may be added.

Polyolefin-containing Materials

Suitable polyolefin-containing materials are any known polymers and copolymers based on ethylene or propylene. Mixtures of pure polyolefins with copolymers are also suitable in principle. The hydrophilicizing additives may also be used in mixtures of polyolefins with other synthetic or natural polymers, for example cellulose, polylactic acid or hemp, in order to provide the polyolefin fibers with permanently hydrophilic properties. The fabric should preferably contain at least 50% by weight of polyolefins. However, the best results are obtained with pure polyolefin-containing nonwovens, i.e. the fabric consists of polyolefins with the usual production-related impurities.

Polymers particularly suitable for the purposes of the teaching according to the invention are listed below: poly(ethylenes), such as HDPE (high-density polyethylene), LDPE (low-density polyethylene), VLDPE (very-low-density polyethylene), LLDPE (linear low-density polyethylene), MDPE (medium-density polyethylene), UHMPE (ultra high molecular polyethylene), VPE (crosslinked polyethylene), HPPE (high-pressure polyethylene); poly(propylenes), such as isotactic polypropylene; syndiotactic polypropylene; metallocene-catalyzed polypropylene, high-impact polypropylene, random copolymers based on ethylene and propylene, block copolymers based on ethylene and propylene; EPM (poly[ethylene-co-propylene]); EPDM (poly[ethylene-co-propylene-co-unconjugated diene]).

Homopolymers and copolymers based on ethylene and propylene are particularly preferred for the purposes of the present invention. In one embodiment of the present invention, therefore, polyethylene on its own is used as the polyolefin; in another embodiment, polypropylene on its own is used as the polyolefin and, in a further embodiment, ethylene/propylene copolymers are used as the polyolefin.

In one particularly preferred embodiment of the invention, the additives are used in polypropylene fibers. Such fibers preferably have a melt flow rate of greater than 10 to 1,500 dg/min. (as measured at 230° C./2.16 kg load). Preferred fibers can have melt flow rates of, for example, 150 to 1,200 or 20 to 25 or 400 to 1,000 dg/min.

The articles, preferably fibers or films, or flat materials, such as nonwovens, of these fibers contain the additives in quantities of 0.1 to 5% by weight, preferably in quantities of 0.5 to 5% by weight and more particularly in quantities of 1.0 to 3% by weight, based on the total weight of the articles.

Nonwovens

Nonwovens can be produced by any of the methods for producing nonwovens known in the prior art as described, for example, in Ullmann's Encyclopedia of Industrial Chemistry, Vol. A 17, VCH Weinheim 1994, pages 572-581. Nonwovens produced by the dry-laid process or by the spunbond process or by the melt flow process are preferred. The dry-laid process starts out from staple fibers which are normally first separated into individual fibers by carding and are then laid together to form the unstabilized nonwoven using an aerodynamic or hydrodynamic process. The unstabilized nonwoven is then heat-treated (“thermobonded”) to give the final nonwoven. To this end, the synthetic fibers are either heated to the extent that their surface melts and the individual fibers are joined together at their points of contact or the fibers are coated with an additive which melts during the heat treatment and thus bonds the individual fibers together. The individual bonds are fixed by cooling. Besides this process, any other processes used in the prior art for bonding nonwovens may of course also be used. By contrast, the spunbond process starts out from individual filaments formed by melt-spinning from extruded polymers which are forced under high pressure through spinning jets. The filaments issuing from the spinning jets are bundled, stretched and laid to form a nonwoven which is normally stabilized by thermobonding.

Impregnation with Emulsions

The impregnation of hydrophilicized polyolefin-containing nonwovens with o/w or w/o emulsions is suitable for cosmetic applications. By combining the polyolefin-containing nonwovens with impregnation with an emulsion, two-phase cleaning wipes can be produced which, initially, have a cooling/cleaning effect on the skin and, ultimately, leave a creaming effect behind on the skin. This effect is evident not only in the case of spunbondeds, but also in the case of carded fleeces containing polypropylene stable fibers. Another advantage of these cosmetic wipes is the minimal “bleeding” in wipes stacked one above the other in packs. It has surprisingly been found that, where the polyolefin-containing wipes are used in combination with impregnating emulsions, there is no sign of any sinking of the outer phase—oil or water—within the pack of cosmetic wipes, even after prolonged storage.

The impregnation with emulsions may be carried out in any of the various process stages, i.e. during or immediately after production of the nonwovens with or without subsequent drying. Impregnation may also be carried out in a second step after bonding before or during conversion. The two impregnation processes may be combined.

The use of emulsions of various fatty compounds produced by the phase inversion temperature process, so-called PIT emulsions, or aqueous emulsions known for the finishing of nonwovens has proved to be particularly suitable for skin-care wipes.

PIT Emulsions

PIT emulsions preferred above all for skin care contain
(a) C₈₋₂₂ and preferably C₁₂₋₁₈ fatty acid alkyl esters,
(b) C₈₋₂₂ and preferably C₁₂₋₁₈ fatty alcohols,
(c) C₈₋₂₂ and preferably C₁₂₋₁₈ alcohol polyglycol ethers and
(d) C₈₋₂₂ and preferably C₁₂₋₁₈ fatty acid partial glycerides

Component (a) of the PIT emulsions may consist of fatty acid alkyl esters corresponding to formula (II):
R¹CO—OR² (II)
in which R¹CO is a linear or branched, saturated or unsaturated acyl group containing 8 to 22, preferably 12 to 18 and more preferably 14 to 16 carbon atoms and R² is a linear or branched alkyl and/or alkenyl group containing 6 to 22 carbon atoms. Typical examples are the esters of caprylic acid, isononanoic acid, capric acid, lauric acid, myristic acid, palmitic acid, palmitoleic acid, stearic acid, isostearic acid, oleic acid, elaidic acid, petroselic acid, elaeostearic acid, arachic acid, gadoleic acid, behenic acid and erucic acid and technical mixtures thereof with caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol and technical mixtures thereof. Wax esters, i.e. fatty acid alkyl esters which have a plastic but firm consistency at 20° C. and which contain a total of 24 to 48 carbon atoms, are preferably used. Typical examples are myristyl myristate, cetearyl isononanoate, cetyl palmitate, cetyl stearate, stearyl palmitate, stearyl stearate and the like.

Fatty alcohols which may be used as component (b) are understood to be primary alcohols which preferably correspond to formula (III):
R³OH (III)
in which R³ is a linear or branched alkyl and/or alkenyl group containing 8 to 22, preferably 12 to 18 and more preferably 14 to 16 carbon atoms. Typical examples are caprylic alcohol, capric alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, elaeostearyl alcohol, arachyl alcohol, gadoleyl alcohol, behenyl alcohol, erucyl alcohol and brassidyl alcohol and the technical mixtures thereof obtained, for example, in the high-pressure hydrogenation of technical methyl esters based on fats and oils or aldehydes from Roelen's oxosynthesis and as monomer fraction in the dimerization of unsaturated fatty alcohols. Technical fatty alcohols containing 12 to 18 carbon atoms, for example coconut oil, palm oil, palm kernel oil or tallow fatty alcohol, are preferred. Guerbet alcohols, i.e. primary alcohols branched in the 2-position which may be obtained by base-catalyzed condensation of fatty alcohols containing 8 to 10 carbon atoms, may also be used. Cetyl alcohol, stearyl alcohol, cetearyl alcohol, behenyl alcohol and mixtures thereof or 2-octyl dodecanol are preferably used.

Alcohol polyglycol ethers which form component (c) are understood to be products of the addition of ethylene and/or propylene oxide onto fatty alcohols of group (b) or oxoalcohols with the same chain length which preferably correspond to formula (IV):
R⁴O(CH₂CHR⁵O)ₙH (IV)
in which R⁴ is a linear or branched alkyl and/or alkenyl group containing 8 to 22, preferably 12 to 18 and more preferably 14 to 16 carbon atoms, R⁵ is hydrogen or methyl and n is a number of 1 to 50. Typical examples are the adducts of on average 1 to 50, preferably 5 to 40 and more preferably 10 to 20 mol ethylene oxide with caprylic alcohol, capric alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and the technical mixtures thereof obtained, for example, in the high-pressure hydrogenation of technical methyl esters based on fats and oils or aldehydes from Roelen's oxosynthesis and as monomer fraction in the dimerization of unsaturated fatty alcohols. Adducts of 10 to 20 mol ethylene oxide with technical fatty alcohols containing 16 to 18 carbon atoms, for example cetearyl alcohol or tallow fatty alcohol, are preferred.

Component (d) of the formulations consists of partial glycerides corresponding to formula (V):
HOCH₂CH(OH)CH₂OCOR⁶ (V)
in which R⁶CO is a linear or branched, saturated or unsaturated acyl group containing 8 to 22, preferably 12 to 18 and more preferably 14 to 16 carbon atoms. The partial glycerides, i.e. monoglycerides, diglycerides and technical mixtures thereof, may still contain small amounts of triglycerides from their production. Typical examples are mono- and/or diglycerides based on caprylic acid, capric acid, lauric acid, palmitic acid, palmitoleic acid, stearic acid, isostearic acid, oleic acid, elaidic acid, petroselic acid, elaeostearic acid, arachic acid, gadoleic acid, behenic acid and erucic acid and technical mixtures thereof. Technical palmitic acid glycerides, stearic acid glycerides, isostearic acid glycerides and/or behenic acid glycerides with a monoglyceride content of 50 to 95% by weight and preferably 60 to 90% by weight are preferably used.

In one preferred embodiment of the invention, PIT emulsions containing—based on the active substance content—30 to 70% by weight of oil components and 70 to 30% by weight of emulsifiers are used as impregnating media. In a particularly preferred embodiment, the emulsions contain—again based on the active substance content—
(a) 2 to 70, preferably 30 to 50% by weight of C₈₋₂₂ fatty acid alkyl esters,
(b) 1 to 40, preferably 10 to 20% by weight of C₈₋₂₂ fatty alcohols,
(c) 10 to 40, preferably 20 to 30% by weight of C₈₋₂₂ alcohol polyglycol ethers,
(d) 1 to 40, preferably 10 to 20% by weight of C₈₋₂₂ fatty acid partial glycerides and
(e) 0 to 70, preferably 10 to 50% by weight of auxiliaries and additives,
   with the proviso that the quantities add up to 100% by weight. The active substance content of the emulsions can be between 0.5 and 80% by weight, depending on the application. With relatively high active substance contents, the flowability of the emulsions decreases dramatically; with relatively low contents, their effectiveness disappears. The emulsions are preferably marketed as concentrates with an active substance content of 10 to 70% by weight which are subsequently diluted to an in-use concentration of 1 to 15% by weight. If desired, the aqueous phase may also contain polyols, preferably up to 15% by weight of glycerol.

So far as the production of the PIT emulsions and other ingredients and active components present in them are concerned, reference is made to European patent application EP 1 097 270.

Aqueous Emulsions for Finishing Nonwovens

The already known aqueous emulsions for finishing nonwovens (WO 03/068282) have also proved to be particularly suitable for impregnating the polyolefin-containing wipes. The cooling and, ultimately, creaming effect could be felt more clearly by comparison with commercially available cosmetic wipes. In addition, there was no sign of the sinking or bleeding of water or oil in packs of wipes thus impregnated, even after prolonged storage.

Preferred emulsions contain 5 to 50% by weight of a component a) melting at 25 to 37° C. selected from the group of paraffins, fatty acid esters, polyhydroxyfatty acid esters, fatty alcohols, alkoxylated fatty acid esters, alkoxylated fatty alcohols and mixtures of these compounds and 5 to 50% by weight of a component b) melting at 40 to 60° C. selected from the group of polyhydroxyfatty acid esters, C₁₄₋₂₂ fatty alcohols, C₁₂₋₂₂ fatty acids, alkoxylated derivatives of the fatty alcohols and esters and mixtures of these components and c) 5 to 25% by weight of water.

Component a) may be selected from a number of compounds known to the expert which must have a melting point in the range from 25 to max. 37° C. Certain paraffins and also fatty acid esters and, in particular, fatty alcohols may be used for this purpose. Preferred paraffins are semisolid paraffins, such as soft paraffin, preferably petrolatum. Suitable fatty alcohols are, for example, dodecanol or ricinolyl alcohol to mention just one representative of the unsaturated fatty alcohols. The use of glycerides, preferably mixtures of partial glycerides and triglycerides, which must have the required melting point of 25 to 37° C. is particularly suitable for the purposes of the present invention. Mixtures of glycerides of C₈₋₁₈ fatty acids are particularly preferred.

Glycerides are mono-, di- and/or triesters of glycerol with fatty acids, i.e. for example caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Typical examples are lauric acid monoglyceride, lauric acid diglyceride, cocofatty acid monoglyceride, cocofatty acid triglyceride, palmitic acid monoglyceride, palmitic acid triglyceride, stearic acid monoglyceride, stearic acid diglyceride, isostearic acid monoglyceride, isostearic acid diglyceride, oleic acid monoglyceride, oleic acid diglyceride, tallow fatty acid monoglyceride, tallow fatty acid diglyceride, behenic acid monoglyceride, behenic acid diglyceride, erucic acid monoglyceride, erucic acid diglyceride and the technical mixtures thereof which may still contain small quantities of triglyceride from the production process.

The use of emulsifier component b) is crucial to the present invention. Glycerol partial esters with C₁₂₋₂₁ fatty acids, preferably glycerol monolaurate, are particularly suitable. Polyglycerol poly-12-hydroxystearate are particularly preferred. Polyol poly-12-hydroxystearates are known substances which are marketed by Cognis Deutschland GmbH & Co. KG under the names of Dehymuls® PWPH or Eumulgin® VL75 or Dehymuls® Sp11.

So far as the production of the aqueous emulsions and other ingredients and active components present therein are concerned, reference is made to International patent application WO 03/068282.

### EXAMPLES

### Example 1

### Water Absorption/Oil Absorption

Preparation:

Cutting the sample nonwovens to size:
   dimensions: 120 mm×120 mm
   number: 3
   weight: at least 1.0 g (several nonwovens)
      Procedure:
1. Weigh nonwoven samples
2. Place in distilled water/oil (Paraffinum liquidum DAB) for 60 seconds (weight nonwoven samples)
3. Hang vertically in machine direction and allow to drip for 120 seconds
4. Re-weigh nonwoven samples
5. Allow to dry for 24 hours (in the case of water)
6. Repeat procedure 1-5 times (in the case of water)

Calculate absorption (water or oil uptake capacity)/%:

$$X \% = \frac{Wet weight - dry weight}{Dry weight} \times 100$$

TABLE 1a
Water absorption capacity (%) of various fabrics, additives spunlaced

| | | 1st | 2nd | 3rd |
|---|---|---|---|---|
| Fabric | Weight | Absorption | Absorption | Absorption |
| Viscose | 60 g/m² | 928 | 974 | 968 |
| Viscose/PES (65/35) | 60 g/m² | 970 | 918 | 905 |
| PES/PP (50/50) | 60 g/m² | 705 | 842 | 941 |
| dried after 2% | | | | |
| Standapol ® 1480 | | | | |
| PES/PP (50/50) | 42 g/m² | 1118 | 1243 | 1226 |
| 2% Standapol ® | | | | |
| 1480 | | | | |

TABLE 1b
Absorption capacity (% by weight) of PP fabric, additive: 2%
Standapol ® 1480

| | Water absorption | Oil absorption |
|---|---|---|
| Meltblown 175 g/m² | 1050 | 1540 |
| Meltblown 400 g/m² | 1160 | 1636 |

### Example 2

### Softness

To test their performance properties, the fabrics of Table 2 were impregnated with Emulgade® CM (Cognis Düsseldorf) in quantities of 2.5 g.m². The fabrics were then dried for 30 mins. at 30° C. and evaluated for softness on a scale of 1 (=very soft) to 4 (=low degree of softness) by a panel of six experienced testers. The results—the average values of three test series—are set out in Table 2.

Table 2:

Softness of various fabrics (additive: hydrophilicizing additive: polyethylene glycol400-dilaurate)

High degree of softness 1, low degree of softness=4 (PP=polypropylene, PES=polyester, SF-SL=staple-fiber spunlace, SB—TB=spunbonded—thermobonded)

| Fabric | Nonwoven | Softness |
|---|---|---|
| Viscose | SF-SL | 2-3 |
| PES/PP (50/50) | SF-SL | 1 |
| 2% by weight additive | | |
| PP | SB-TB | 3-4 |
| PP | SB-TB | 2 |
| 2% by weight additive | | |

1. A wipe comprising a non-woven sheet comprising permanently hydrophilicized polymer fibers, the hydrophilicized polymer fibers containing constituent units provided by olefin monomers and a hydrophilicizing additive; the nonwoven sheet impregnated with at least one member selected from the group consisting of spin finishes, aqueous solutions and emulsions.

2. The wipe as claimed in claim 1, wherein the nonwoven sheet contains at least 25% by weight of the permanently hydrophilicized fibers containing constituent units provided by olefin monomers.

3. The wipe as claimed in claim 1, wherein the nonwoven sheet comprises permanently hydrophilicized polyolefin fibers and process-related impurities.

4. The wipe as claimed in claim 1, wherein, the olefin monomers comprises propylene.

5. The wipe as claimed in claim 1, wherein the hydrophilicizing additive comprises a component of the formula:
A-B-C-B-A (I)
where
A represents an R—COO group in which R is independently a saturated, branched or unbranched C₇₋₂₁ alkyl group,
B represents a group (CₙH₂ₙO)ₖ in which n is an integer of 2 to 4 and k has a value of 1 to 15, and
C is a linear or branched alkylene group containing at least 2 and at most 6 carbon atoms which optionally can be interrupted by one or more oxygen atoms.

6. The wipe as claimed in claim 1, wherein the hydrophilicizing additive comprises polyalkylene glycol diesters.

7. The wipe as claimed in claim 1, wherein the nonwoven sheet is impregnated with an aqueous emulsion containing 5 to 50% by weight of a component a) melting at 25 to 37° C. selected from the group consisting of paraffins, fatty acid esters, polyhydroxyfatty acid esters, fatty alcohols, alkoxylated fatty acid esters, alkoxylated fatty alcohols and mixtures thereof and 5 to 50% by weight of a component b) melting at 40 to 60° C. selected from the group consisting of polyhydroxyfatty acid esters, C₁₄₋₂₂ fatty alcohols, C₁₂₋₂₂ fatty acids, alkoxylated fatty alcohols, alkoxylated fatty acid esters and mixtures thereof and c) 5 to 25% by weight of water.

8. The wipe as claimed in claim 1, wherein the nonwoven sheet is impregnated with an aqueous PIT emulsion containing:
(a) C₈₋₂₂ fatty acid alkyl esters,
(b) C₈₋₂₂ fatty alcohols,
(c) C₈₋₂₂ alcohol polyglycol ethers and
(d) C₈₋₂₂ fatty acid partial glycerides

9. A process for the production of wipes, which comprises impregnating a nonwoven sheet comprising permanently hydrophilicized polyolefins fibers with at least one member selected from the group consisting of spin finishes, aqueous solutions and emulsions.

10. A wipe comprising an impregnated nonwoven sheet comprising permanently hydrophilicized polyolefin fibers.

11. The wipe as claimed in claim 2, wherein, the olefin monomers comprises propylene.

12. The wipe as claimed in claim 2, wherein the hydrophilicizing additive comprises a component of the formula:
A-B-C-B-A (I)
where
A represents an R—COO group in which R is independently a saturated, branched or unbranched C₇₋₂₁ alkyl group,
B represents a group (CₙH₂ₙO)ₖ in which n is an integer of 2 to 4 and k has a value of 1 to 15, and
C is a linear or branched alkylene group containing at least 2 and at most 6 carbon atoms which optionally can be interrupted by one or more oxygen atoms.

13. The wipe as claimed in claim 2, wherein the hydrophilicizing additive comprises polyalkylene glycol diesters.

14. The wipe as claimed in claim 2, wherein the nonwoven sheet is impregnated with an aqueous emulsion containing 5 to 50% by weight of a component a) melting at 25 to 37° C. selected from the group consisting of paraffins, fatty acid esters, polyhydroxyfatty acid esters, fatty alcohols, alkoxylated fatty acid esters, alkoxylated fatty alcohols and mixtures thereof and 5 to 50% by weight of a component b) melting at 40 to 60° C. selected from the group consisting of polyhydroxyfatty acid esters, C₁₄₋₂₂ fatty alcohols, C₁₂₋₂₂ fatty acids, alkoxylated fatty alcohols, alkoxylated fatty acid esters and mixtures thereof and c) 5 to 25% by weight of water.

15. The wipe as claimed in claim 2, wherein the nonwoven sheet is impregnated with an aqueous PIT emulsion containing:
(a) C₈₋₂₂ fatty acid alkyl esters,
(b) C₈₋₂₂ fatty alcohols,
(c) C₈₋₂₂ alcohol polyglycol ethers and
(d) C₈₋₂₂ fatty acid partial glycerides

16. The wipe as claimed in claim 3, wherein, the olefin monomers comprises propylene.

17. The wipe as claimed in claim 3, wherein the hydrophilicizing additive comprises a component of the formula:
A-B-C-B-A (I)
where
A represents an R—COO group in which R is independently a saturated, branched or unbranched C₇₋₂₁ alkyl group,
B represents a group (CₙH₂ₙO)ₖ in which n is an integer of 2 to 4 and k has a value of 1 to 15, and
C is a linear or branched alkylene group containing at least 2 and at most 6 carbon atoms which optionally can be interrupted by one or more oxygen atoms.

18. The wipe as claimed in claim 3, wherein the hydrophilicizing additive comprises polyalkylene glycol diesters.

19. The wipe as claimed in claim 3, wherein the nonwoven sheet is impregnated with an aqueous emulsion containing 5 to 50% by weight of a component a) melting at 25 to 37° C. selected from the group consisting of paraffins, fatty acid esters, polyhydroxyfatty acid esters, fatty alcohols, alkoxylated fatty acid esters, alkoxylated fatty alcohols and mixtures thereof and 5 to 50% by weight of a component b) melting at 40 to 60° C. selected from the group consisting of polyhydroxyfatty acid esters, C₁₄₋₂₂ fatty alcohols, C₁₂₋₂₂ fatty acids, alkoxylated fatty alcohols, alkoxylated fatty acid esters and mixtures thereof and c) 5 to 25% by weight of water.

20. The wipe as claimed in claim 3, wherein the nonwoven sheet is impregnated with an aqueous PIT emulsion containing:
(a) C₈₋₂₂ fatty acid alkyl esters,
(b) C₈₋₂₂ fatty alcohols,
(c) C₈₋₂₂ alcohol polyglycol ethers and
(d) C₈₋₂₂ fatty acid partial glycerides
